(19) United States
(12) Patent Application Publication
(10) Pub. No.: US 2014/0069626 A1
(43) Pub. Date: Mar. 13, 2014

(54) TEMPERATURE CONTROL SYSTEM AND TEMPERATURE CONTROL METHOD THEREOF

(71) Applicants: INVENTEC (PUDONG) TECHNOLOGY CORPORATION, Shanghai (CN); INVENTEC CORPORATIO, Taipei City (TW)

(72) Inventors: Ching-Hung Lin, Taipei City (TW); Chien-An Chen, Taipei City (TW); Chih-Chien Lin, Taipei City (TW); Kai-Yang Tung, Taipei City (TW); Fei-Yau Lu, Taipei City (TW); Hsueh-Hui Chang, Taipei City (TW)

(73) Assignees: INVENTEC COPORATIO, Taipei City (TW); INVENTEC (PUDONG) TECHNOLOGY CORPORATION, Shanghai (CN)

(21) Appl. No.: 13/846,791

(22) Filed: Mar. 18, 2013

(30) Foreign Application Priority Data
Sep. 12, 2012 (CN) 201210337123.5

(51) Int. Cl. G06F 1/20

(52) U.S. Cl. CPC G06F 1/20
USPC 165/287

(57) ABSTRACT

A temperature control system used for a server system includes a liquid cooling module used for performing heat exchange for the server system through a first fluid and a second fluid, an air-cooled module used for providing a heat-dissipating airflow to the server system; and a control unit coupling the liquid cooling module and the air-cooled module. The control unit is used for adjusting a plurality of temperature adjustment parameters based on the environmental condition of the server system and thereby controlling the liquid cooling module and the air-cooled module at the same time, so as to make the liquid cooling module and the air-cooled module perform a heat-dissipating process according to the corresponding temperature adjustment parameters, and to reduce a environment temperature of the server system. The control unit is further used for adjusting the order of the temperature adjustment parameters based on a scheduling condition.

This non-provisional application claims priority under 35 U.S.C. §119(a) on Patent Application No(s). 201210337123.5 filed in China, P.R.C. on Sep. 12, 2012, the entire contents of which are hereby incorporated by reference.

### BACKGROUND OF THE INVENTION

1. Field of the Invention

The disclosure relates to a temperature control system, more particularly to a temperature control system configured for adjusting a plurality of temperature adjustment parameters at the same time.

2. Description of the Related Art

Due to user's characteristics nowadays, the lifecycle of the “cloud” system or the lifecycle of other products related to network applications is extremely short. As a consequence, the amount of system users goes up and down significantly. Since traditional data centers lack extensibility and flexibility, they do not meet today's requirements.

To address the problems of the traditional data center, a container data center is introduced. The container data center does not require a particular space for installation. In contrast, it only requires water, electricity, and internet which are needed to run it. Moreover, when expansion of the container data center is required, it can be achieved by stacking multiple container data centers, so as to expand the container data center flexibly.

However, as the container data center is expanded, the power required grows dramatically. Furthermore, in the container data center, the power used for dissipating heat and cooling processes accounts for a large proportion of the power consumption. Hence, in order to perform the heat dissipating process in an energy-saving way for reducing the power consumption, how to establish heat dissipating system configured for controlling the cooling mechanism dynamically based on the conditions is an issue to be addressed in the related art.

### SUMMARY OF THE INVENTION

In an embodiment, the disclosure provides a temperature control system configured for a server system. The temperature control system comprises a liquid cooling module, an air-cooled module, and a control unit. A liquid cooling module is configured for performing heat exchange for the server system through a first fluid and a second fluid. An air-cooled module is configured for providing a heat-dissipating airflow to the server system. A control unit couples the liquid cooling module and the air-cooled module. The control unit is configured for adjusting a plurality of temperature adjustment parameters based on the environmental condition of the server system and thereby controlling the liquid cooling module and the air-cooled module at the same time, so as to make the liquid cooling module and the air-cooled module perform a heat-dissipating process according to the corresponding temperature adjustment parameters, and to reduce a environment temperature of the server system. The control unit is further configured for adjusting the order of the temperature adjustment parameters based on a scheduling condition.

The disclosure further provides a temperature control method configured for a temperature control system. The temperature control method is configured for a server system. In the method, a plurality of temperature adjustment parameters are adjusted according to the environmental state of the server system. The priority in terms of adjusting temperature adjustment parameters is based on a scheduling condition. A liquid cooling module and an air-cooled module of the temperature control system are controlled at the same time based on the temperature adjustment parameters, to make the liquid cooling module and the air-cooled module perform a heat dissipating process in the server system based on the corresponding temperature adjustment parameters, so as to lower a environment temperature of the server system. The liquid cooling module is configured for performing heat exchange for the server system through a first fluid and a second fluid. The air-cooled module is configured for providing a heat dissipating airflow to the server system.

### BRIEF DESCRIPTION OF THE DRAWINGS

The disclosure will become more fully understood from the detailed description given herein below for illustration only, thus not limiting the disclosure, wherein:

FIG. 1 is a block diagram of a temperature control system according to an embodiment of the disclosure;

FIG. 2 is a flow chart of a temperature control method according to an embodiment of the disclosure;

FIG. 3 is a schematic layout of a temperature control system according to another embodiment of the disclosure;

FIG. 4A and FIG. 4B are flow charts of a temperature control method according to another embodiment of the disclosure; and

FIG. 5A and FIG. 5B are flow charts of a temperature control method according to still another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The embodiments of the disclosure provide a temperature control system. By setting the scheduling order and by controlling different heat dissipating modules and different cooling modules at the same time based on the environment temperature, the temperature control system is able to dissipate heat of the server system with lower power consumption. Moreover, the embodiments of the disclosure further provide a temperature control method which involves controlling a plurality of temperature adjustment parameters at the same time, based on the scheduling condition and the environment temperature, so as to control a plurality of heat dissipating modules and cooling modules. For the sake of simplicity, the following embodiments are introduced as examples of the disclosure which are enforceable. Furthermore, in the figures and embodiments, the same symbols of the components/members/steps are used to represent the same or similar parts where possible.

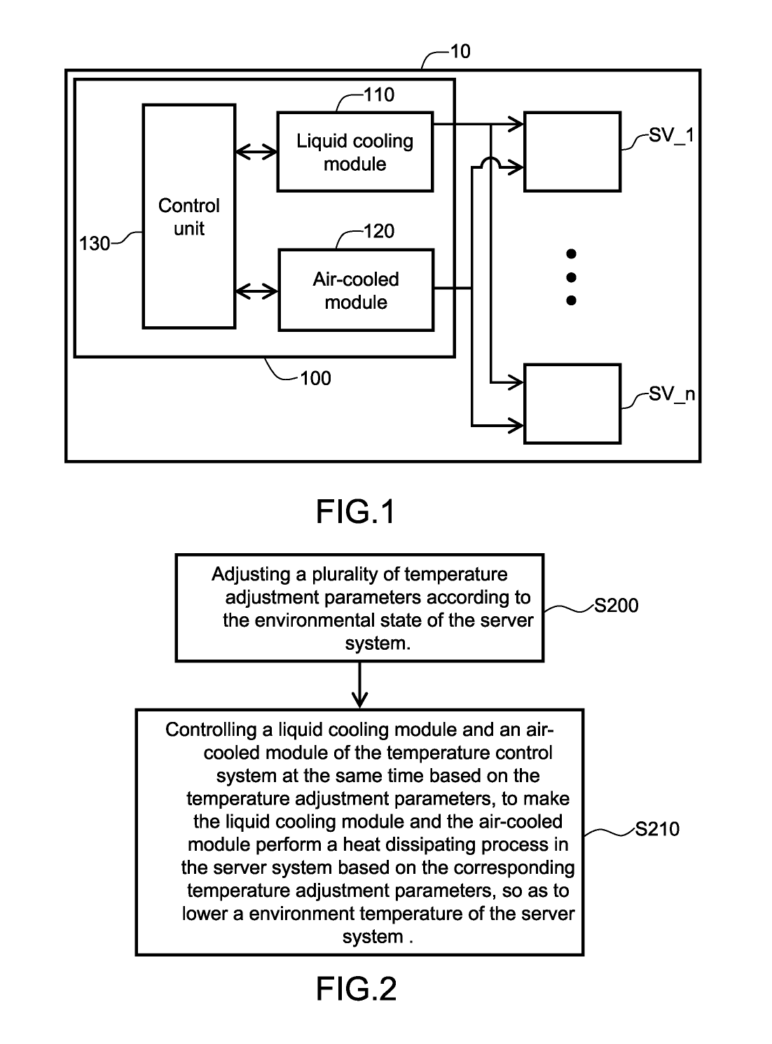

FIG. 1 is a block diagram of a temperature control system according to an embodiment of the disclosure. FIG. 2 is a flow chart of a temperature control method according to an embodiment of the disclosure. In this embodiment, a temperature control system 100 is disposed in a server system 10, and is configured for performing heat dissipating processes for a plurality of server groups SV_1˜SV_n of the server system 10.

Please refer to FIG. 1 and FIG. 2 at the same time. The temperature control system 100 comprises a heat dissipation module 110 and 120 as well as a control unit 130. The control unit is coupled to the liquid cooling module 110 and the air-cooled module 120. Based on the environmental condition of the server system 10, for example, the humidity of the sever system, the temperature of the server groups SV_1˜SV_n, the state that whether the gateway of the server system 10 is open and the operational state of the heat dissipation module 110 and 120, the control unit is configured for adjusting a plurality of temperature adjustment parameters correspondingly (S200). Thereby, the control unit 130 is configured to control the liquid cooling module 110 and the air-cooled module 120 of the temperature control system 100 according to the temperature adjustment parameters, so as to make the liquid cooling module 110 and the air-cooled module 120 dissipate heat of the server system 10 according to the temperature adjustment parameters, thereby lowering the environment temperature of the server system 10 (S210).

Specifically, a system administrator may set up the scheduling condition based on the cooling capacity of the liquid cooling module 110 and the air-cooled module 120, so as to make the control unit 130 determine the order of adjusting the temperature adjustment parameters according to the scheduling condition which has been set up beforehand. Consequently, the temperature control system 100 is configured for dissipating heat of the server system 10 in a most appropriate way. For example, at first, the control unit 130 is configured to define a predetermined period based on the set scheduling condition. When the environment temperature is higher than the threshold temperature, the control unit is configured for adjusting a part of the temperature adjustment parameters first during the predetermined period, so as to utilize the cooling mechanism with a weaker cooling capacity to lower the environment temperature of the server system 10. For example, when the heat dissipating modules 110 and 120 are a chiller and a cooling fan respectively, the control unit 130 may change the valve control parameters to increase the flow of the cold water, or may increase the rotational speed control parameters of the cooling fan to increase the wind speed of the heat dissipating airflow. With regard to cooling capacity, a weaker cooling capacity indicates lower power consumption.

Meanwhile, if the temperature control system 100 is able to lower the environment temperature to be less than the threshold temperature, the control unit 130 is configured to make the heat dissipating module 110 and 120 stop the heat dissipation process, and return the temperature adjustment parameters which have been adjusted to the default values. Additionally, after the predetermined period, if the temperature control system 100 detects that the environment temperature is still higher than the threshold temperature, the control unit 130 further adjusts another part of the temperature adjustment parameters according to the scheduling condition, so as to utilize other cooling mechanisms with better cooling capacities to lower the environment temperature of the server system 10, for example, lowering the cold water output pressure of the chiller, or lowering the temperature of the cold water.

In other words, when the environment temperature is slightly higher than the threshold temperature so that the temperature control system 100 is able to lower the temperature to be less than the threshold temperature, the temperature control system 100 stops further lowering the temperature of the server system 10. On the other hand, when the environment temperature is significantly higher than the threshold temperature, the temperature control system 100 activates all the cooling mechanisms to rapidly lower the environment temperature of the server system 10 after the predetermined period, so as to rapidly lower the environment temperature to be less than the threshold temperature. Thereby, system malfunctions can be avoided.

In a normal heat dissipation system, once the environment temperature is higher than the threshold temperature, the heat dissipation system activates all the cooling mechanisms to dissipate heat. Though lowering the environment temperature of the server system, such a method leads to a waste of power usage. Compared to a normal heat dissipation system, in this embodiment, the control method of the temperature control system 100 is based on the environment temperature and employs a multiple-steps control method in terms of adjusting different temperature adjustment parameters, so as to lower the environment temperature of each of the server groups SV_1˜SV_n to a normal operational temperature. Thereby, unnecessary power consumption can be avoided.

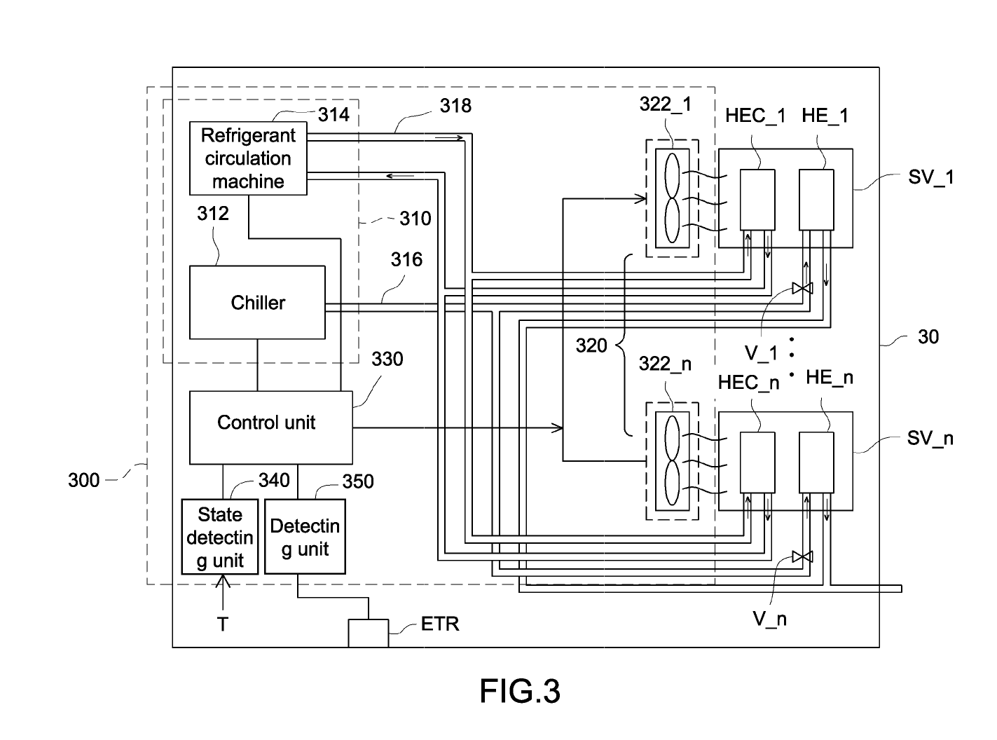

To explain the embodiments of the disclosure more clearly, FIG. 3 is a schematic layout of a temperature control system according to another embodiment of the disclosure.

In this embodiment, the temperature control system 300 comprises a liquid cooling module 310, an air-cooled module 320, a control unit 330, a state detecting unit 340, and a detecting unit 350. Furthermore, in the server system 30, the operational temperature of each of the server groups SV_1˜SV_n is the main cause of the rise of the environment temperature T. Hence, in this embodiment, the liquid cooling module 310 and air-cooled module 230 are designed and disposed primarily for the sake of lowering the temperature of each of the server groups SV_1˜SV_n.

Please refer to FIG. 3. The liquid cooling module 310 is configured to perform heat exchange for the server system via a first fluid and a second fluid based on the scheduling condition and the environment temperature. In this embodiment, the liquid cooling module 310 comprises a chiller 312 and a refrigerant circulation machine 314. The first fluid and the second fluid are water and refrigerant, respectively. In the liquid cooling module 310, the chiller 312 and the refrigerant circulation machine 314 output cold water and refrigerant, respectively, through a first conduit 316 and the second conduit 318, respectively, so as to perform heat exchange for each of the server groups SV_1˜SV_n. Specifically, the arrows in the first conduit 316 and the second conduit 318, respectively, represent the direction of flowing water and refrigerant in the first conduit 316 and in the second conduit 318. Furthermore, the refrigerant output by the refrigerant circulation machine 314 is, for example, the coolant.

The air-cooled module 320 is configured to provide cooling airflow to the server system 30 based on the scheduling condition and the environment temperature T. In this embodiment, the air-cooled module 320 comprises a plurality of fan units 322_1˜322_n of the server groups SV_1˜SV_n. The fan units 322_1˜322_n are configured to provide cooling airflow to each of the server groups SV_1˜SV_n.

Specifically, in the server system 30, in order to lower the temperature of each of the server groups SV_1˜SV_n, the liquid cooling module 310 utilizes the cold water output by the chiller 312 to perform heat exchange via the first conduit 316 transferring the cold water to the heat exchangers HE_1˜HE_n of each of the server groups SV_1˜SV_n. Subsequently, water which has absorbed the heat is transferred to outside the server system 30 through the first conduit 316, so as to be discharged. On the other hand, the fan module 320 utilizes the fan units 322_1˜322_n to provide cooling airflow, so as to enhance the thermal convection of the server groups SV_1˜SV_n. Thereby, heat dissipation of the server groups SV_1˜SV_n can be accelerated.

Moreover, in the server groups SV_1˜SV_n, the temperature of Central Processing Unit (CPU) is higher than other components because it processes a large amount of tasks. As a result, the refrigerant circulation machine 314 outputs refrigerant via a refrigerant pump deriving refrigerant from the refrigerant storage tank, and transfers refrigerant to the heat exchangers HEC_1˜HEC_n for each of the CPUs via the second conduit 218, in order to perform heat exchange. Then, after heat exchange, the refrigerant is configured to absorb heat and to change phase, for example, evaporating from liquid carbon dioxide to gaseous carbon dioxide. Gaseous carbon dioxide, subsequently, returns to liquid carbon dioxide by being compressed by the refrigerant circulation machine 314 after being transferred through the second conduit 218. In other words, each of the server groups SV_1˜SV_n can dissipate heat not only by cold water, but also by refrigerant cooling the CPU of the server groups SV_1˜SV_n.

In this embodiment, based on the liquid cooling module 310 and the air-cooled module 320 disposed in the temperature control system 300, the temperature adjustment parameters which can be adjusted by the control unit 330 comprise the output pressure parameters and the cold water temperature parameters of the chiller 312, the pump frequency parameters of the refrigerant circulation machine 314, the valve control parameters of the first conduit 316, and the rotational speed parameters of the fan units 322_1˜322_n. The output pressure parameters correspond to the cold water output pressure of the chiller 312, and the cold water temperature parameters corresponds to the cold water temperature of the chiller 312. The pump frequency parameters correspond to the refrigerant derivation frequency of the refrigerant circulation machine 314, so as to adjust the output flow of the refrigerant. The valve control parameters correspondingly control the opening range of a plurality of valve v_1˜v_n of the first conduit 316, so as to control the cold water flow flowing in to each of the server groups SV_1˜SV_n. The rotational speed control parameters correspond to the rotational speed of each of the fan units 322_1˜322_n, so as to adjust wind speed of the cooling airflow. Adjusting the output pressure parameters and the cold water temperature parameters improves heat dissipation outcomes more effectively but leads to more power consumption.

The state detecting unit 340 is coupled to the control unit, and is configured to detect the environment temperature T and the operational state of the temperature control system 300. The state detecting unit 340 returns the environment temperature T and the operation state to the control unit 330, so as to make control unit 330 perform heat dissipation process or error detection based on the environment temperature T and the operational state.

The detecting unit 350 is coupled to the control unit 330, and is configured to detect whether the gateway ETR of the server system is open or not. When the detecting unit 350 discovers that the gateway is open, the control unit 330 adjusts the rotational speed parameters to the maximum output value, so as to make the fan units 322_1˜322_n provide airflow with maximum speed.

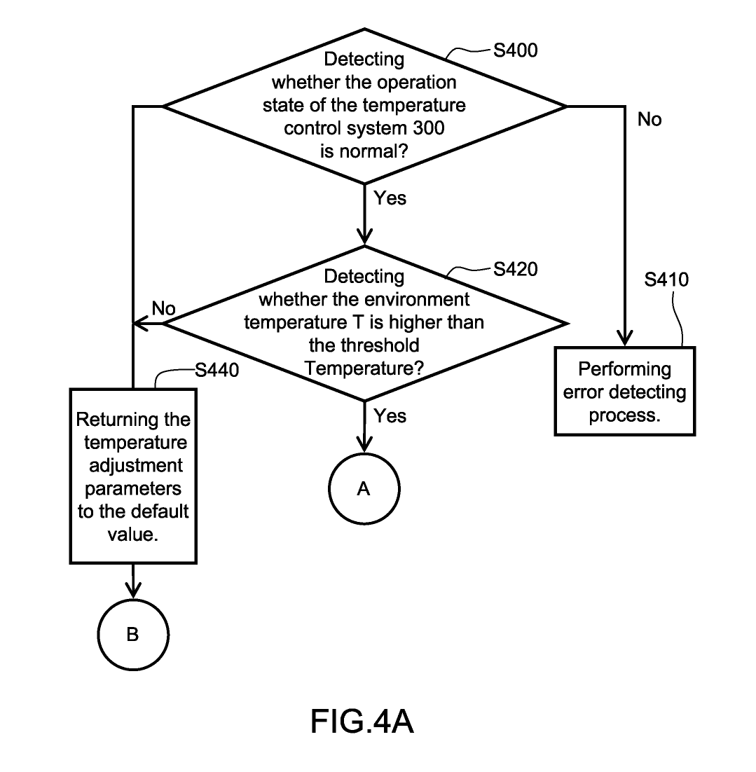

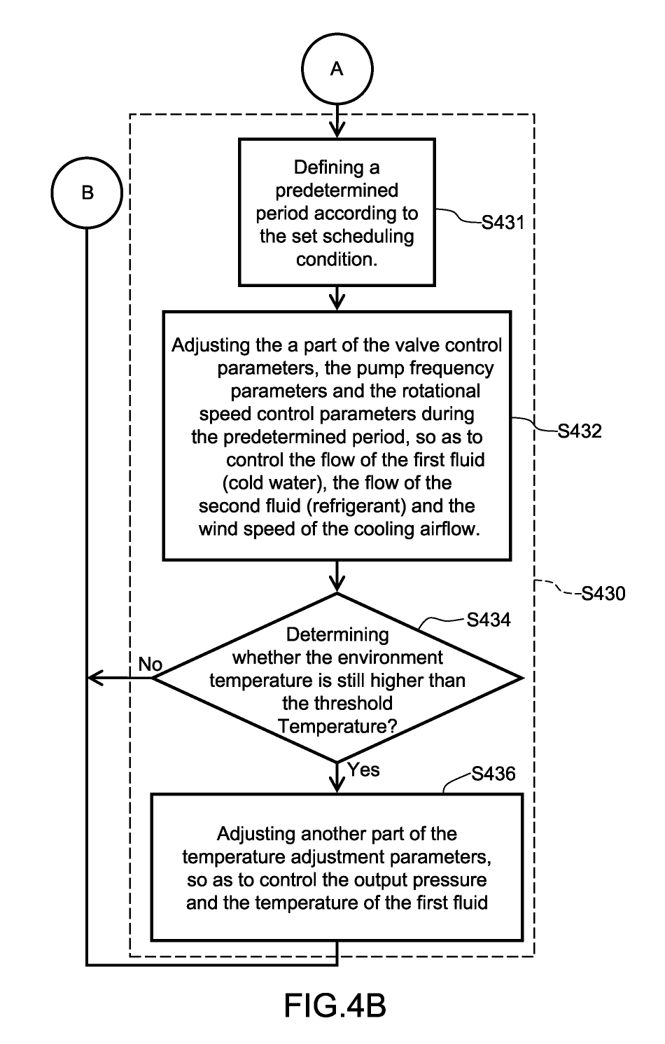

Furthermore, the temperature control method of the temperature control system 300 is shown in FIG. 4A and FIG. 4B. FIG. 4A and FIG. 4B are flow charts of a temperature control method according to another embodiment of the disclosure. Please refer to FIG. 3, FIG. 4A and FIG. 4B. At first, the state detecting unit 340 detects whether the operational state of the temperature control system 300 is normal (S400). When the operational state of the temperature control system 300, detected by the state detecting unit 340, is abnormal, the state detecting unit 340 makes the control unit 330 perform an error detecting process (S410), so as to fix the abnormal state of the temperature control system 300. The abnormal operational state is, for example, fire alarm signals, leakage occurring in the chiller 312 or the refrigerant circulation machine 314, insufficient pressure of the refrigerant storage tank of the refrigerant circulation machine 314, liquid level of the refrigerant storage tank in the refrigerant circulation machine 314 being too low, excessive humidity in the server system 30, malfunctions in the temperature sensor of the server groups SV_1˜SV_n, or malfunctions in the fan units 322_1˜322_n.

Subsequently, when the state detecting unit 340 determines that the operational state of temperature control system 300 is normal, the state detecting unit 340 further detects whether the environment temperature T is higher than the threshold temperature (S420). If the environment temperature T of the server system 30 is less than the threshold temperature, the method returns to step S400 and repeats detecting the operational state and the environment temperature T of the server system 30 continuously. The threshold temperature can be set by the system administrators according to the operational temperature of the server groups SV_1˜SV_n, and the disclosure is not limited thereto.

When the state detecting unit 340 determines that the operational state of the temperature control system 300 is normal but the environment temperature T is higher than the threshold temperature, the control unit 330 make the liquid cooling module 310 and air-cooled module 320 dissipate heat according to the scheduling condition and the environment temperature T, so as to lower the environment temperature T (S430). After the heat dissipation process is finished, the control unit 330 returns the temperature adjustment parameters to the default value (S440) and returns to the step S400.

Specifically, when performing the heat dissipation process, the control unit 330 first defines a predetermined period according to the set scheduling condition (S431). Additionally, adjusting the valve control parameters, the pump frequency parameters and the rotational speed control parameters consumes less power. Therefore, in the process of heat dissipation (S430), the control unit 330 first adjusts the valve control parameters, pump frequency parameters, and the rotational speed control parameters, according to the environment temperature T, during the predetermined period according to the scheduling condition. Thereby, the control unit 330 controls the cold water flow, the output flow of the refrigerant, and the wind speed of the cooling airflow (S432). Moreover, when the difference between the environment temperature T and the threshold temperature T increases (given that the environment temperature T is higher than the threshold temperature T), the control unit 330 adjusts the valve control parameters, pump frequency parameters and the rotational speed control parameters accordingly until each of the parameters is adjusted to the maximum output values, namely, the opening range of the valve v_1˜v_n, deriving frequency of the refrigerant pump, and the rotational speed of the fan units 322_1˜322_n are all at the maximum values.

In step S432, the control unit 330 may adjust the valve control parameters, pump frequency parameters, and the rotational speed control parameters simultaneously, or may adjust them in sequence with a fixed time interval (for example, 2 seconds), and the disclosure is not limited thereto.

After going through that heat dissipation process in the predetermined period, the state detecting unit 340 determines whether the environment temperature is still higher than the threshold temperature (S434). After going through the heat dissipation process in the predetermined period, if the environment temperature T is less than the threshold temperature, the control unit 330 returns the temperature adjustment parameters to the default values (S440), and returns to step S400.

After going through the heat dissipation process in the predetermined period, if the environment temperature is still higher than the threshold temperature, the control unit 330 further adjusts the output pressure parameters and the cold water parameters of the chiller 312 based on the scheduling condition, so as to control the temperature and the output pressure of the cold water (S436). Similar to above-mentioned parameters adjustment procedures, when the difference between the environment temperature and the threshold temperature increases (given the environment temperature is higher than the threshold temperature), the control unit 330 adjusts output pressure parameters and the cold water temperature parameters accordingly, until each of the parameters is adjusted to the maximum values. Furthermore, the control unit 330 may adjust the output pressure parameters and the cold water parameters at the same time, or in sequence with a fixed time interval (for example, 30 seconds), and the disclosure is not limited thereto.

In other words, in this embodiment, during the predetermined period, the set scheduling condition make the control unit 330 simultaneously (in some embodiments, it can be set in sequence by the system administers) adjust the temperature adjustment parameters with lower power consumption. If the environment temperature T of the server system 30 cannot be lowered to be less than the threshold temperature by the heat dissipation process during the predetermined period, based on the scheduling condition, the control unit 330 simultaneously adjust (in some embodiments, it can be set by the system administrators) the temperature adjustment parameters with higher power consumption. That is, when the temperature control system 300 fails to lower the environment temperature T to be less than the threshold temperature in the predetermined period, the control unit 330 adjusts all the temperature adjustment parameters to lower the temperature of each of the server groups SV_1˜SV_n, until the environment temperature T returns to be a point less than the threshold temperature, which is in the normal operational temperature range. Then, the control unit 330 makes the liquid cooling module 310 and the air-cooled module 320 stop performing heat dissipation process, and returns each of the temperature adjustment parameters to the default values.

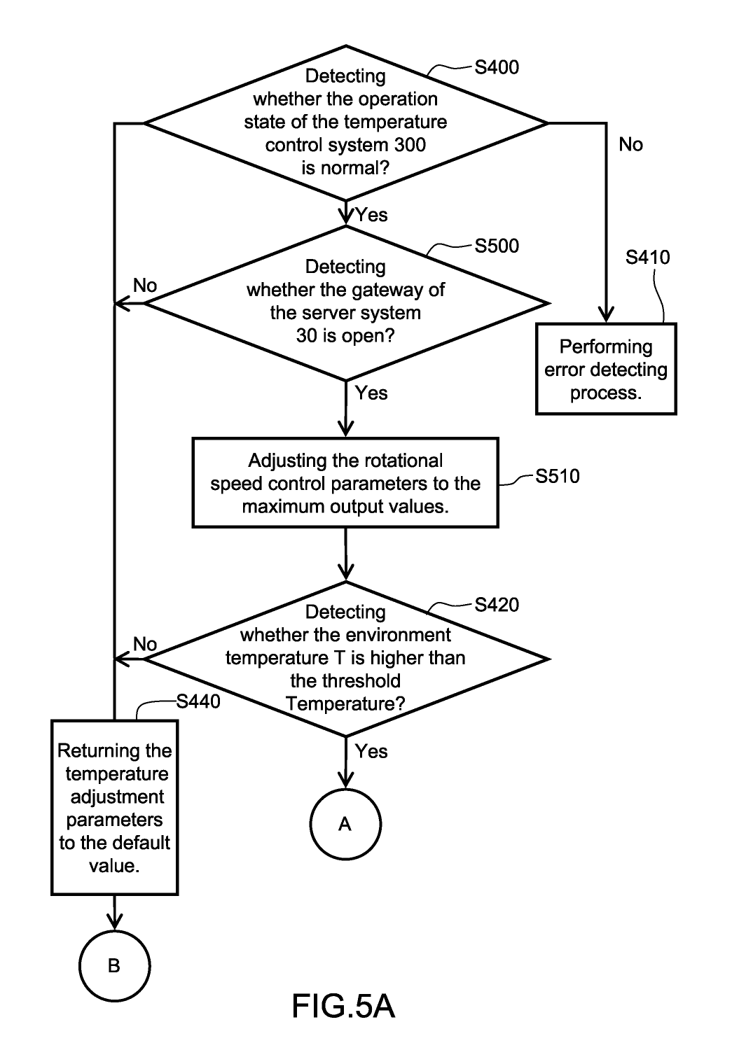

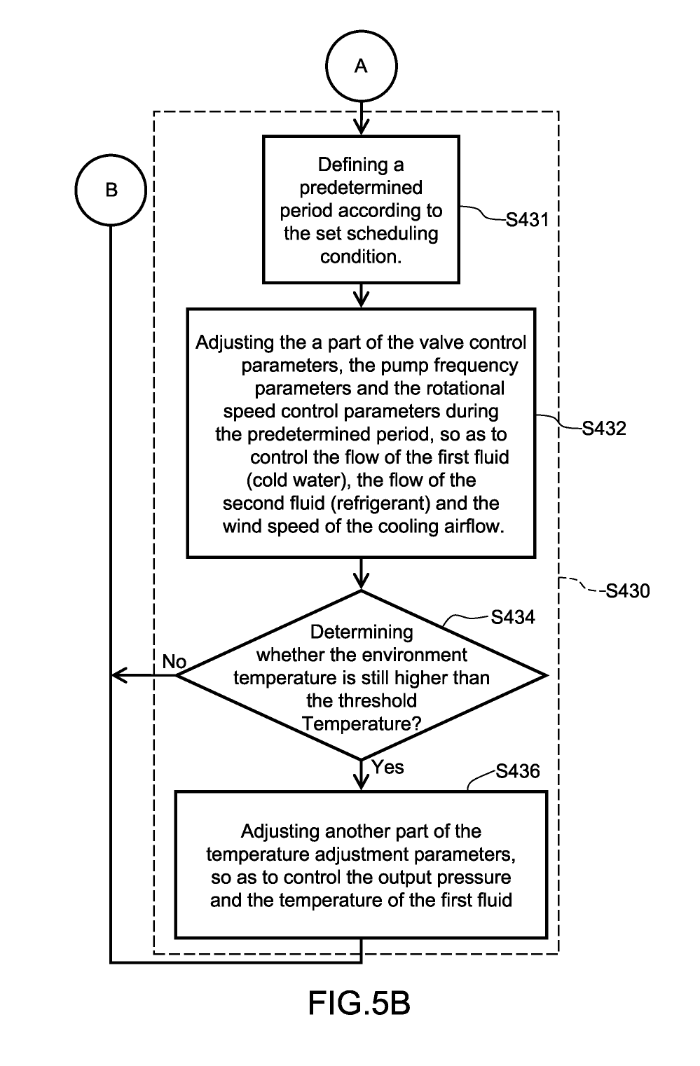

On the other hand, the temperature control method of the embodiments of the disclosure further takes the consequences of the change of the wind field during when opening the gateway ETR of the server system into account. Please refer to FIG. 5A and FIG. 5B. FIG. 5A and FIG. 5B are flow charts of a temperature control method according to still another embodiment of the disclosure. In this embodiment, the procedure of the temperature control method is similar to FIG. 4A and FIG. 4B, wherein the differences between them lie in that the embodiment of FIG. 5A and FIG. 5B further includes the step S500 and the step S510 for operating under the condition that the gateway is open.

Please refer to FIG. 3, FIG. 5A and FIG. 5B. The gateway ETR of the server system 30 being open affects the original wind field inside the server system 30, and therefore deteriorates the heat convection efficiency. Thereby, the environment temperature T increases. Consequently, after confirming that the operation state of the temperature control system 300 is normal (S400), the temperature control system 300 detects whether the gateway ETR of the server system 30 is open by utilizing the detecting unit 350 (S500). When the detecting unit 350 does not detect that the gateway ETR of the server system 30 is open, the step S420 is implemented to determine whether the environment temperature is higher than the threshold temperature. The following processes are carried out as the embodiment of FIG. 4A and FIG. 4B.

When detecting the gateway ETR of the server system 30 is open, the detecting unit 350 make the control unit 330 adjust the rotational speed control parameters to the maximum output values (S510), so as to make the fan units 322_1˜322_n provide the cooling airflow with the maximum wind speed so that the wind field inside the server system 30 can be stable. The remaining procedures are similar to the embodiment in FIG. 4A and FIG. 4B so the description can be found in the embodiment in FIG. 4, and therefore will not repeat here again.

What is claimed is:

1. A temperature control system configured for a server system, the temperature control system comprising:
a liquid cooling module configured for performing heat exchange for the server system through a first fluid and a second fluid;
an air-cooled module configured for providing a heat-dissipating airflow to the server system; and
a control unit coupling the liquid cooling module and the air-cooled module, the control unit being configured to adjust a plurality of temperature adjustment parameters based on the environmental condition of the server system and thereby controlling the liquid cooling module and the air-cooled module at the same time, so as to make the liquid cooling module and the air-cooled module perform a heat-dissipating process according to the corresponding temperature adjustment parameters, and to reduce an environment temperature of the server system, wherein the control unit is further configured to adjust the order of the temperature adjustment parameters based on a scheduling condition.

2. The temperature control system according to claim 1, wherein the control unit defines a predetermined period based on the scheduling condition, when the environment temperature is higher than a threshold temperature, the control unit is configured to perform the heat dissipating process according to the scheduling condition, so as to adjust a part of the temperature adjustment parameters during the predetermined period, and to control the flows of the first fluid and the second fluid as well as the wind velocity of the heat dissipating airflow, and after the predetermined period, when the environment temperature is still higher than the threshold temperature, the control unit is configured to adjust another part of the temperature adjustment parameters, so as to control the output pressure and the temperature of the first fluid.

3. The temperature control system according to claim 1, further comprising:
a detecting unit coupled to the control unit, the detecting unit being configured to detect whether the gateway of the server system is open, wherein when the detecting unit discovers that the gateway of the server system is open, the control unit adjusts the temperature adjustment parameters of the heat dissipating airflow to a maximum output value.

4. The temperature control system according to claim 1, further comprising:
a state detecting unit coupled to the control unit, the state detecting unit being configured to detect the environment temperature and a operating state of the temperature control system, wherein the state detecting unit is configured to send the environment temperature and the operating state back to the control unit, and to make the control unit perform the heat dissipating process or an error detecting process based on the environment temperature and the operating state.

5. The temperature control system according to claim 4, wherein
when the state detecting unit determines that the operating state is normal and the environment temperature is higher than a threshold temperature, the control unit performs the heat dissipating process, so as to lower the environment temperature; and
when the state detecting unit determines that the operating sate is abnormal, the control unit is made to perform the error detecting process, so as to fix the temperature control system.

6. A temperature control method configured for a temperature control system, the temperature control method being configured for a server system and comprising:
adjusting a plurality of temperature adjustment parameters according to the environmental state of the server system, wherein the priority in terms of adjusting temperature adjustment parameters is based on a scheduling condition; and
controlling a liquid cooling module and an air-cooled module of the temperature control system at the same time based on the temperature adjustment parameters, to make the liquid cooling module and the air-cooled module perform a heat dissipating process in the server system based on the corresponding temperature adjustment parameters, so as to lower a environment temperature of the server system, wherein the liquid cooling module is configured to perform heat exchange for the server system through a first fluid and a second fluid, and the air-cooled module is configured to provide a heat dissipating airflow to the server system.

7. The temperature control method configured for the temperature control system according to claim 6, wherein the heat dissipating process further comprises the following steps:
defining a predetermined time based on the scheduling condition; and
adjusting a part of the temperature adjustment parameters according to the scheduling condition during the predetermined period, so as to control the flows of the first fluid and the second fluid as well as the wind velocity of the heat dissipating airflow.

8. The temperature control method configured for the temperature control system according to claim 6, wherein the heat dissipating process further comprises the following steps:
determining whether the environment temperature is still higher than the threshold temperature after the predetermined period; and
adjusting another part of the temperature adjustment parameters when the environment temperature is still higher than the threshold temperature, so as to control the output pressure and the temperature of the first fluid.

9. The temperature control method configured for the temperature control system according to claim 6, further comprising:
detecting whether the gateway of the server system is open; and
adjusting the temperature adjustment parameters which control the heat dissipating airflow to a maximum output value when discovering that the gateway of the server system is open.
